(19) United States
(12) Patent Application Publication
(10) Pub. No.: US 2007/0201115 A1
(43) Pub. Date: Aug. 30, 2007

(54) Data Generating Apparatus, and Print Apparatus

(75) Inventors: Shigetaka YOSHIDA, Komaki-shi (JP); Norio MIZUTANI, Mie-ken (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/679,622

(22) Filed: Feb. 27, 2007

(30) Foreign Application Priority Data
Feb. 28, 2006 (JP) 2006-054200

(51) Int. Cl. H04N 1/46

(52) U.S. Cl. 358/538

(57) ABSTRACT

A data generating apparatus being provided with: an extracting unit that extracts text image which is a part of the text of a file stored in a storage medium and picture image which is a part of the picture of the same; a setting unit that, for each file, sets a text thumbnail arranging region to which the text image is outputted and a picture thumbnail arranging region to which the picture image is outputted in accordance with file specifying information for specifying each file; and an index data generating unit that arranges the text image and the picture image in the set text thumbnail arranging region and the picture thumbnail arranging region, respectively, as thumbnails together with the file specifying information. Therefore, generated index data can be displayed on a display unit and can be printed by a printing unit.

### CROSS-REFERENCE TO RELATED APPLICATIONS

This Non-provisional application claims priority under 35 U.S.C. §119 (a) on patent application No. 2006-054200 filed in Japan on Feb. 28, 2006, the entire contents of which are hereby incorporated by reference.

### BACKGROUND OF THE INVENTION

1. Field of the Invention

The present invention relates to a data generating apparatus that generates an image data for displaying an index of a file (files) using thumbnails, and a print apparatus equipped with such data generating apparatus for printing the index.

2. Description of Related Art

Print apparatuses such as printer, MFP (Multiple Function Peripheral) include apparatuses having a direct print function of selectively printing a file (files) stored in, when attached, a portable storage medium such as USB (Universal Serial Bus) memory. By such direct print function, a file can be easily and conveniently printed without using an external device such as personal computer to instruct printing. An apparatus having an index print function for reading files from a storage medium and printing on a paper a plurality of images indicating the contents of the files all together in a form of a list is known (see e.g., Japanese Patent Application Laid-Open No. 2005-349822). Using such index print function, the user is able to intuitively select a file (files) desiring to print from a great number of files stored in the storage medium through the use of the index print function.

The user is able to find the intended file by checking the content of the file by index print. The user then operates an operation panel arranged on the print apparatus to select the file desiring to print by designating the file name and the like, and executes direct print of the selected file.

The conventional direct print is generally targeted for graphics files photographed by a digital camera. Therefore, thumbnail images obtained by expanding image of the graphics file are printed in a list in the conventional index print. However, when the target file of the index print is only text created by text editor or word processor software, or when the majority of the file is text and the image is only partial, the thumbnail images cannot be obtained by expanding the target file. Thus, the thumbnail images may not be displayed even if index print is performed, whereby the user may not be able to recognize the content of the file. As a result, it becomes difficult for the user to find the intended file, and a great amount of time is required until printing the intended file.

Consideration is made for when having the target of direct print is document file created by text editor or word processor software. To this end, the index is desirably printed by printing some of the text contained in the document file as thumbnails in a form of a list on a paper. In this case, however, the thumbnails are not printed for the graphics files not containing the text, that is, files containing only images, as opposed to the above case. A new problem arises in that the user cannot recognize the content of the file containing only images.

Furthermore, the storage capacity of the portable storage medium is recently becoming larger. Therefore, it is anticipated in the future that the user will carry the portable storage medium stored with the document files created with word processor software for meetings in companies, administrative institutions, and the like, and the graphics files for source materials of the relevant document files. In this case, the user will need a long time until direct print of the file when the contents of both the graphics files and the document files are not recognized by index print. The document files often contain not only text but also images. With regard to such document files, the thumbnails obtained by extracting and expanding the images cannot be printed in a list, which is inconvenient for users who desire to select the file based on the content of the images contained in the document file.

Furthermore, when the document files created with word processor software for meetings, and the graphics files for source materials of the relevant document files are stored in the same portable storage medium, the file is desirably selected and printed by displaying the index on the display rather than printing the index, as opposed to when having the graphics file photographed by a digital camera as the target. This is because when having only the graphics files photographed by a digital camera as the target, what kind of picture is photographed, whether the picture is focused, whether the exposure is appropriate, and the like must be checked in order to print the graphics files as photographs. However, when the document files for meeting and the graphics files are stored in the storage medium, the user simply needs to check which file should be printed when printing the file since the user is aware of the content of each file. Furthermore, when the indexes of the document files for meeting and the graphics files are printed, secrets may leak out from the printed indexes. Therefore, the indexes of the document file for meeting and the graphics files are desirably not printed, if possible.

### BRIEF SUMMARY OF THE INVENTION

In view of the above, the present invention aims to provide a data generating apparatus, having a file containing at least one of either a text or a picture as a target, for index displaying the relevant content in a state easily identifiable by the user. The present invention also aims to provide a print apparatus equipped with the data generating apparatus for printing the index.

The picture data generating apparatus (original claim 1) of the present invention is provided to solve the above problems.

According to the data generating apparatus according to the present invention, the text data and the picture data are extracted from each file. A text thumbnail arranging region and a picture thumbnail arranging region are set in association with each file. Furthermore, a text thumbnail is arranged in the text thumbnail arranging region, a picture thumbnail is arranged in the picture thumbnail arranging region, and index data in which file specifying information is added to the respective thumbnail is generated. The index data can be displayed on the display apparatus. The index data can be printed according to the print apparatus of the present invention.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing an inner configuration example when a print apparatus according to the present invention is applied to an MFP (Multiple Function Peripheral);

FIG. 2 is a view showing an example of programs stored in a ROM;

FIG. 3A, FIG. 3B and FIG. 3C are flow charts showing the procedures of the index data generating process of embodiment 1 by an index data generating function (function of index data generating apparatus according to the present invention) of the MFP serving as a print apparatus according to the present invention;

FIG. 4 is a schematic view showing an example of storing file specifying information of each file in a memory;

FIG. 5A and FIG. 5B are schematic views showing an output example of the index when the user selects the index of the type “PICTURE ONLY”;

FIG. 6A and FIG. 6B are schematic views showing the output example of the index when the user selects the index of the type “TEXT ONLY”;

FIG. 7A and FIG. 7B are schematic views showing the output example of the index when the user selects the index of the type “PICTURE & TEXT”;

FIG. 8A and FIG. 8B are flow charts showing the procedures of the index data generating process of embodiment 2 by an index data generating function (function of index data generating apparatus according to the present invention) of the MFP serving as a print apparatus according to the present invention;

FIG. 9A and FIG. 9B are schematic views showing an example when the file specifying information and the text thumbnail corresponding to each file are outputted to the first display screen or the first printing paper, and the picture thumbnail is outputted to the second display screen or the second printing paper;

FIG. 10A and FIG. 10B are schematic views showing an example when a plurality of picture thumbnails is outputted to the second display screen or the second printing paper for one file; and

FIG. 11 is a schematic view showing the output result of watermark index data of embodiment 3 by an index data generating function (function of index data generating apparatus according to the present invention) of the MFP serving as a print apparatus according to the present invention.

### DETAILED DESCRIPTION OF THE PRESENT INVENTION

The embodiments of the present invention will now be described with reference to the drawings.

### Embodiment 1

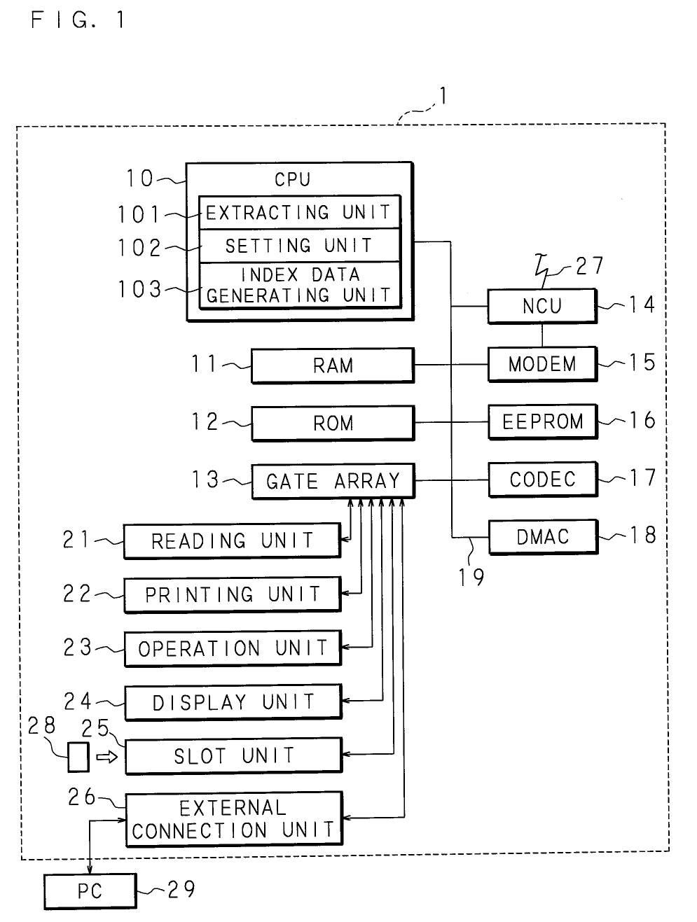

FIG. 1 is a block diagram showing an inner configuration example in a case where a print apparatus of the present invention is applied to an MFP (Multiple Function Peripheral). The MFP 1 serving as the print apparatus of the present invention also has a function serving as a data generating apparatus according to the present invention.

MFP 1 is configured by a CPU 10, a RAM 11, a ROM 12, a gate array 13, an NCU (Network Control Unit) 14, a modem 15, an EEPROM 16, a codec 17, a DMAC (Direct Memory Access Controller) 18 and the like. These components are connected to each other by a bus line 19. The bus line 19 includes an address bus, a data bus, and a control signal line. A reading unit 21, a printing unit 22, an operation unit 23, a displaying unit 24, a slot unit 25, an external connection unit 26 and the like are connected to the gate array 13. A PSTN 27 is connected to the NCU 14.

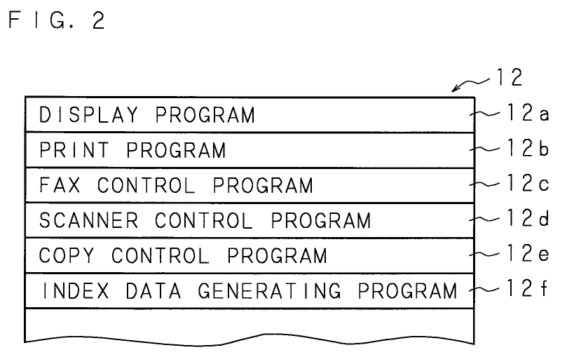

The CPU 10 controls the operation of the entire MFP 1. As shown in FIG. 2, various programs such as display program 12a, print program 12b, FAX control program 12c, scanner control program 12d, copy control program 12e, index data generating program 12f and the like are stored in the ROM 12.

The display program 12a is a program for displaying file name, image (print image) and the like on the displaying unit 24. The print program 12b is a program for controlling the printing unit 22 and performing printing. The index data generating program 12f is a program for generating index data for displaying a plurality of images all together in a form of a list on one screen or on a plurality of screens, that is, for displaying a so-called index. The index data generated by the index data generating program 12f can be displayed on the displaying unit 24 through the display program 12a, or may be printed on a printing medium (normally printing paper, transparent sheet for OHP and the like) by controlling the printing unit 22 through the print program 12b.

The CPU 10 reads and executes the display program 12a, the print program 12b and the index data generating program 12f to functions as an extracting unit 101, a setting unit 102, an index data generating unit 103 and the like of the present invention.

The FAX control program 12c, the scanner control program 12d, and the copy control program 12e stored in the ROM 12 are programs for controlling the FAX function, scanner function and copy function of the MFP 1.

The NCU 14 is connected to the MFP 1. The NCU 14 performs network control such as line connection/disconnection with respect to a public switched telephone network (PSTN) 27.

The RAM 11 is used as a line buffer memory for working area of the CPU 10, expansion area and the like of the read picture.

The modem 15 performs modulation, demodulation and the like of the facsimile data.

The ROM 12 also stores data of various set values and the like necessary for executing the programs, in addition to each program shown in FIG. 2.

The EEPROM 16 stores various flags, setting information and the like necessary for executing each program described above.

The codec 17 performs coding the facsimile data of the picture data and decoding which is the opposite of coding.

The DMAC 18 mainly performs write and read of data to the RAM 11 without through the CPU 10, that is, controls the so-called direct memory access function.

The gate array 13 functions as an input/output interface between the CPU 10 and each unit such as the reading unit 21.

The reading unit 21 includes an image sensor, an LED light source and the like, and reads images of characters and/or figures from a document.

The printing unit 22 prints images of characters and/or figures on a printing paper through an appropriate method such as inkjet method, thermal transfer method.

The operation unit 23 includes a key switch group such as ten key, character key. The operation unit 23 functions as an accepting unit, and accepts the key operation by the user on the key switch group, and to the CPU 10, gives a signal corresponding to the accepted key operation. The operation unit 23 also includes a direct print key to be hereinafter described.

The displaying unit 24 includes a display panel such as an LCD for displaying the operation state of the MFP1, an operation guidance for the user and the like. The displaying unit 24 also displays the index data generated by the index data generating program 12f, as hereinafter described.

The slot unit 25 includes a plurality of types of connectors for connecting various types of storage medium 28 such as smart medium, compact flash®, USB memory. To each connector, the storage medium 28 of the corresponding type can be inserted and removed. Therefore, the slot unit 25 has a function serving as a reader/writer for reading and writing data with respect to the storage medium 28.

The external connection unit 26, which includes connection ports corresponding to standards such as Centronics parallel interface or USB, exchanges data and signal with the personal computer (PC) 29.

The MPF 1 as the print apparatus according to the present invention having above configuration performs data operation process such as transferring the data stored in the storage medium 28 attached to the slot unit 25 to the PC 29 or deleting the data in response to the access from the PC 29. The MFP 1 can perform read and write on different types of storage medium 28 attached to the slot unit 25.

In addition to the function of printing the data in response to the instruction from the PC 29 as a peripheral device of the PC 29, the MFP 1 has a function of reading the data from the storage medium 28 and directly printing the relevant data, that is, a so-called direct print function when the storage medium 28 storing pictures photographed by the digital camera and the like is attached to the slot unit 25. The MFP 1 extracts files stored in the storage medium 28, for example, text image 34 (text thumbnail) and/or picture image 33 (picture thumbnail) of JPEG and the like contained in the file of PDF (Portable Document Format) format developed by Adobe Systems Incorporated as index image, and outputs the same with the corresponding file specifying information 32 to display or print an index, as hereinafter described.

Therefore, the MFP 1 displays and/or prints the index with the text image 34 and/or picture image 33 of each file as thumbnails together with the file specifying information 32, whereby the user is able to visibly check the thumbnails or the result of being printed as index, and the user is able to easily find the intended file.

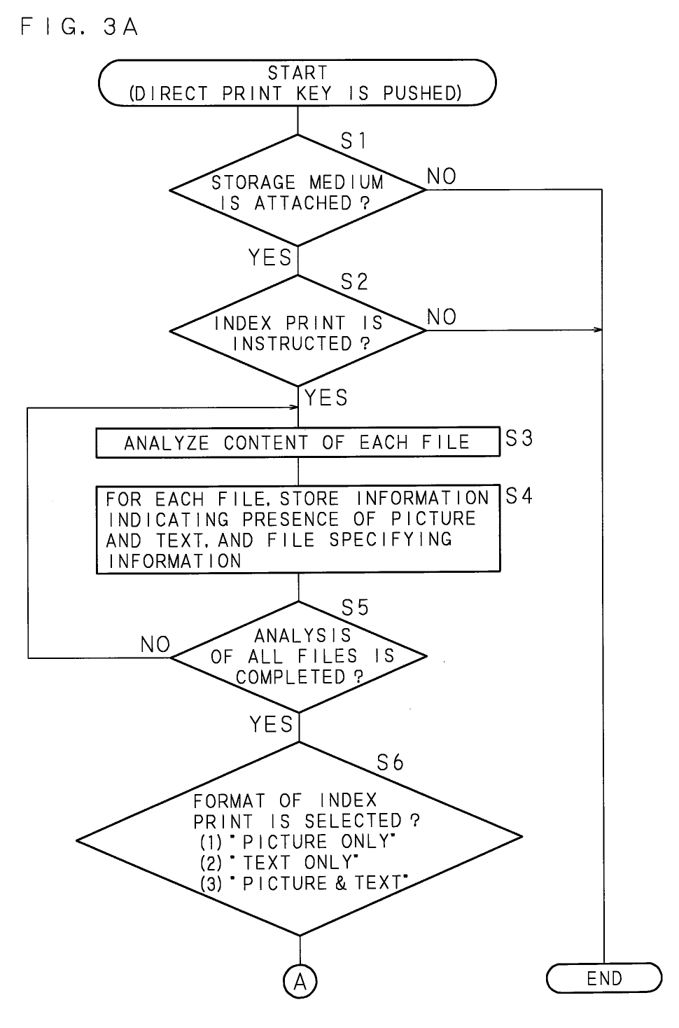

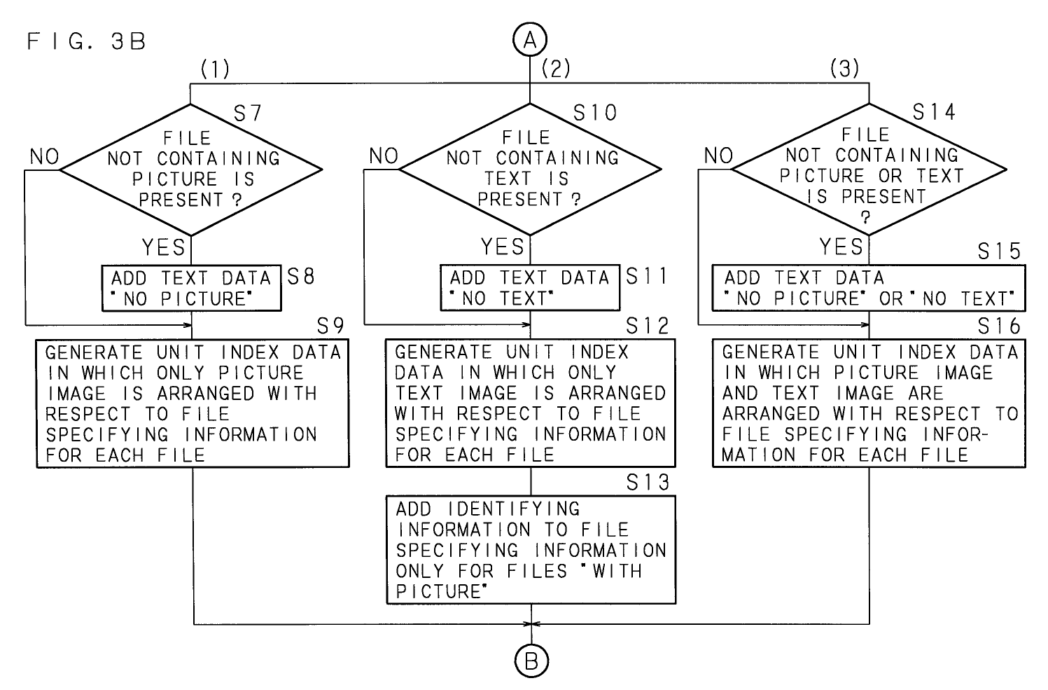

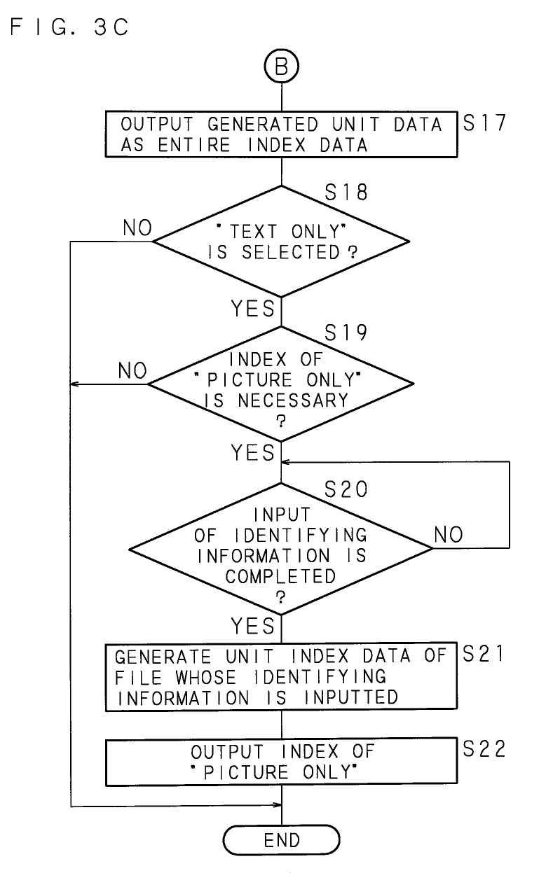

The procedures of the index data generating process of embodiment 1 by the index data generating function (function of index data generating apparatus according to the present invention) of the MFP 1 as the print apparatus according to the present invention will now be described with reference to the flow charts of FIG. 3A, FIG. 3B and FIG. 3C. The generating process of the index data is executed according to the instruction by the user for the user to search for and select the intended file when direct print of the file stored in the storage medium 28 and the like. The MFP 1 can display the generated index data on the displaying unit 24 as index image, and the index image displayed on the displaying unit 24 can be printed on an appropriate printing paper by the printing unit 24.

When the user pushes the direct print key in the key switch group of the operation unit 23 of the MFP 1, the CPU 10 of the MFP 1 executes the index data generating process according to the procedures of the flow charts of FIG. 3A, FIG. 3B and FIG. 3C, prior to printing the file for direct print of the file stored in the storage medium 28.

First, the CPU 10 of the MFP 1 judges whether or not the storage medium 28 is attached to the slot unit 25 (step S1). When the storage medium 28 is not attached (step S1: NO), the file to be direct printed is not present, and thus the CPU 10 terminates the process.

When the storage medium 28 is attached to the slot unit 25 (step S1: YES), the CPU 10 monitors whether or not the instruction for index print given by the user is accepted (step S2). When the instruction of index print is not accepted (step S2: NO), the process of index print is not performed. For example, index print is not necessary when all the files are to be printed. On the other hand, when index print is instructed (step S2: YES), the CPU 10 executes the index data generating program 12f according to the accepted instruction and executes the following processes.

First, the CPU 10 sequentially analyzes the content of each file stored in the storage medium 28 in a predetermined order (step S3). For each file from the result of analysis, the CPU 10 associates and stores in the memory (RAM 11) the information indicating the presence of pictures and the information indicating the presence of text, and the file specifying information 32 (size, number of pages and the like) specifying each file (step S4).

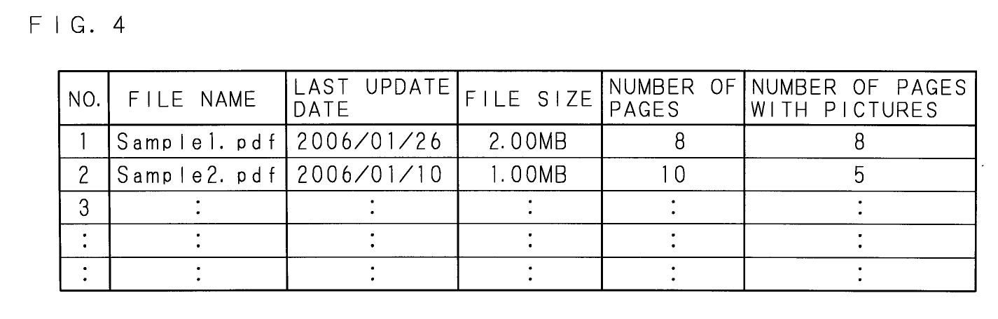

FIG. 4 is a schematic view showing an example of storing the file specifying information 32 in the memory (RAM 11). The file name, last update date, file size, number of pages, and number of pages with pictures (number of pages including pictures) are stored corresponding to each file. These information are mainly added to the index as the file specifying information 32, as hereinafter described.

The CPU 10 then judges whether or not the analysis of all the files stored in the storage medium 28 attached to the slot unit 25 is completed (step S5). When the analysis of all the files is not completed (step S5: NO), the CPU 10 returns the process to step S3 and repeats the processes of step S3 and S4 described above.

When the analysis of all the files is completed (step S5: YES), the CPU 10 then monitors which type of index the user selects (step S6). Note that the selection of the type of index is accepted when the user operates a predetermined key arranged on the operation unit 23, and the corresponding signal is given to the CPU 10. In addition, the operation or the like through the software key displayed on the displaying unit 24 is also possible. Three types, that is, “PICTURE ONLY”, “TEXT ONLY” and “PICTURE & TEXT” are prepared as types of index.

When the user selects the index of the type “PICTURE ONLY” (step S6: (1)), as shown in FIG. 3B, the CPU 10 judges the presence of the file not containing the picture by referencing the content of the file specifying information 32 of all the files stored in the RAM 11 (step S7). When the file not containing the picture is present (step S7: YES), the CPU 10 adds the text data “no picture” to the file not containing the picture (step S8), and proceeds the process to step S9. On the other hand, when the file not containing the picture is not present (step S7: NO), the CPU 10 directly proceeds the process to step S9. Therefore, in this case, the text data “no picture” is not added to any of the files.

The CPU 10 then extracts the picture data corresponding to at least a part of the picture from each file containing the picture as the picture data for picture thumbnail. The CPU 10 generates the picture image 33 based on the picture data extracted in this manner, and arranges the same in a picture thumbnail arranging region set at a predetermined position with respect to an arranging region of the corresponding file specifying information 32 and generates one set of unit index data with respect to each file containing the picture (step S9).

In step S9, the CPU 10 generates the picture image 33 for picture thumbnail based on the text data of “no picture” with respect to the file not containing the picture, that is, each file added with the text data “no picture”. The CPU 10 arranges the picture image 33 generated in this manner in the picture thumbnail arranging region set at the predetermined position with respect to the arranging region of the corresponding file specifying information 32 and generates one set of unit index data for each file not containing the picture.

On the other hand, when the index of the type “TEXT ONLY” is selected by the user in step S6 (step S6: (2)), as shown in FIG. 3B, the CPU 10 judges the presence of the file not containing the text (character) by referencing the content of the file specifying information 32 of all the files stored in the RAM 11 (step S10). When the file not containing the text is present (step S10: YES), the CPU 10 adds the text data “no text” to the file not containing the text (step S11), and proceeds the process to step S12. On the other hand, when the file not containing the text is not present (step S10: NO), the CPU 10 directly proceeds the process to step S12. Therefore, in this case, the text data “no text” is not added to any of the files.

The CPU 10 then extracts the text data corresponding to at least a part (e.g., few lines) of the text from each file containing the text as the text data for text thumbnail. The CPU 10 generates the text image 34 based on the text data extracted in this manner, and arranges the same in a text thumbnail arranging region set at a predetermined position with respect to the arranging region of the corresponding file specifying information 32 and generates one set of unit index data with respect to each file containing the text (step S12).

In step S12, the CPU 10 generates the text image 34 for text thumbnail based on the text data “no text” with respect to the file not containing the text, that is, each file added with the text data “no text”. The CPU 10 arranges the text image 34 generated in this manner in the text thumbnail arranging region set at the predetermined position with respect to the arranging region of the corresponding file specifying information 32 and generates one set of unit index data for each file not containing the text.

Next, the CPU 10 adds a unique identification number (e.g., numbers 1, 2, 3, . . . , and the like) as identifying information to the file specifying information 32 only for files in which the information indicating “WITH PICTURE” are contained in the file specifying information 32, that is, files containing the picture (step S13). As hereinafter described, when the user designates the identifying information (identification number), the picture contained in the file with the designated identifying information (identification number) is additionally outputted as thumbnail. The identifying information is described using character resource (numbers, alphabets and the like), which order is defined in advance, and is sequentially added different character resource in descending order and the like with respect to a plurality of files that require an addition of identifying information.

When the index of the type “PICTURE & TEXT” is selected by the user in step S6 (step S6: (3)), as shown in FIG. 3B, the CPU 10 judges the presence of the file not containing the picture or the text (character) by referencing the content of the file specifying information 32 of all the files stored in the RAM 11 (step S14). When the file not containing either the picture or the text is present (step S14: YES), the CPU 10 adds the text data “no picture” to the file not containing the picture and the text data “no text” to the file not containing the text, respectively (step S15), and proceeds the process to step S16. On the other hand, when the file not containing either the picture or the text is not present (step S14: NO), that is, when all the files contain both the picture and the text, the CPU 10 directly proceeds the process to step S16. Therefore, in this case, text data “no picture” and “no text” is not added to any of the files.

Next, the CPU 10 extracts the picture data corresponding to at least a part of the picture from each file containing only the picture as the picture data for picture thumbnail. The CPU 10 generates the picture image 33 based on the picture data extracted in this manner and also generates the text image 34 for thumbnail based on the text data “no text”, and arranges the respective image in the picture thumbnail arranging region and the text thumbnail arranging region set at respective predetermined positions with respect to the arranging region of the corresponding file specifying information 32 and generates one set of unit index data with respect to each file containing only the picture (step S16).

Also, the CPU 10 extracts the text data corresponding to at least a part (e.g., few lines) of the text from each file containing only the text as the text data for text thumbnail. The CPU 10 generates the text image 34 based on the text extracted in this manner and also generates the picture image 33 for picture thumbnail based on the text data “no picture”, and arranges the respective image in the text thumbnail arranging region and the picture thumbnail arranging region set at respective predetermined positions with respect to the arranging region of the corresponding file specifying information 32 and generates one set of unit index data with respect to each file containing only the text (step S16).

Furthermore, the CPU 10 extracts the picture data corresponding to at least a part of the picture and the text data corresponding to at least a part (e.g., few lines) of the text from all the files containing both the picture and the text as picture data and text data for picture thumbnail and text thumbnail. The CPU 10 generates the picture image 33 and the text image 34 based on the picture data and the text data extracted in this manner, arranges the respective image in the picture thumbnail arranging region and the text thumbnail arranging region set at respective predetermined positions with respect to the arranging region of the corresponding file specifying information 32 and generates one set of unit index data with respect to each file containing both the picture and the text (step S16).

After the generation of the unit index data is completed for all the files as described above, the CPU 10 generates an entire index data by laying out each unit index data in a predetermined shape (format). The entire index data generated in the above manner is outputted (displayed) on the displaying unit 24 by executing the display program 12a by the CPU 10. When the user operates the operation unit 23 to instruct printing, the CPU 10 executes the printing program 12b, and the printing unit 22 outputs (prints) the entire index data on the appropriate printing paper.

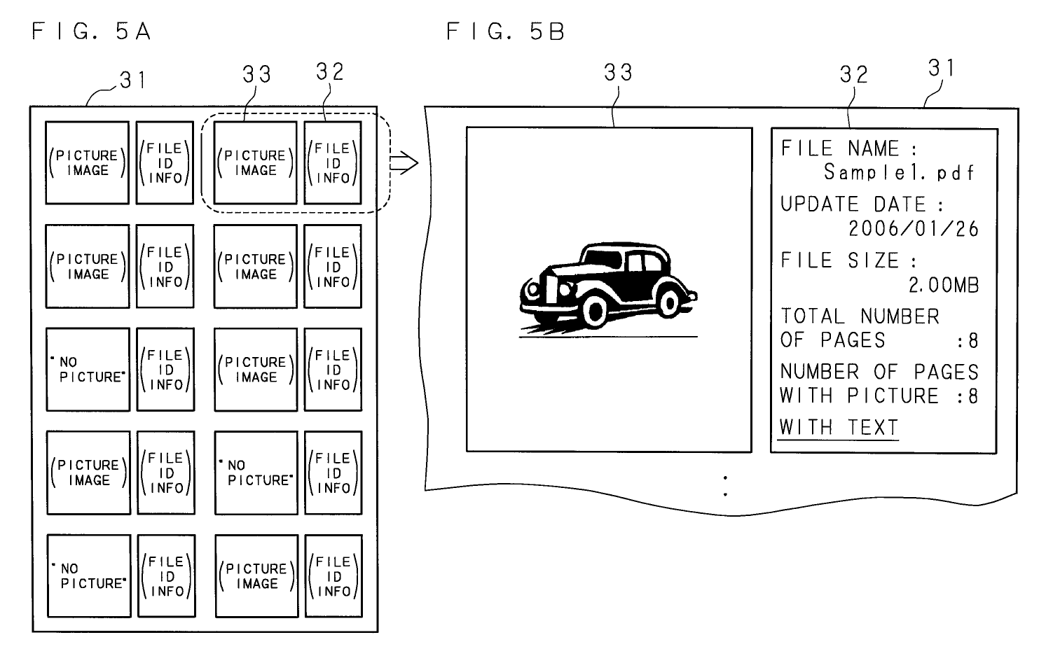

FIG. 5A and FIG. 5B are schematic views showing an output example, that is, the display example on the displaying unit 24 or the print result by the printing unit 22 of the index when the user selects the index of the type “PICTURE ONLY”. Note that FIG. 5A shows the display example or the print result of the index (entire index data) on one display screen or one sheet of printing paper 31, and FIG. 5B shows the display example or the print result of the index data (unit index data) of one of the files.

The unit index data of each file, that is, the file specifying information 32 and the picture image 33 contained in the file specified by the file specifying information 32 are displayed or printed side by side (associated) in the left and right direction on the display screen or the printing paper 31. That is, the CPU 10 displays or prints the index image (picture image 33 in this case) as thumbnail on the picture thumbnail arranging region corresponding to the type (picture thumbnail in this case) of the thumbnail which is outputted by the selected type of index. However, the CPU 10 does not display or print the index image (text image 34 in this case) on the text thumbnail arranging region corresponding to the type (text thumbnail in this case) of the thumbnail which is to be outputted by the non-selected type of index.

In the file specifying information 32, information indicating the presence of text in addition to the file name, last update date, file size, total number of pages, number of pages with picture, as shown in FIG. 4 are contained. The information indicating the presence of text contained in the file specifying information 32 is auxiliary outputted to indicate whether or not a non-selected type data, which is the data of the index image (text image 34 in this case) to be arranged in the thumbnail arranging region (text thumbnail arranging region in this case) corresponding to the type (text thumbnail in this case) of the thumbnail to be outputted by the non-selected type of index, is contained in the respective file. Then, the user searches for the intended file from the content of the file specifying information 32 and the picture image 33 (picture thumbnail).

In the display state or the print result of the index shown in FIG. 5A, the picture image 33 (picture thumbnail) are arranged in a line at a predetermined position on the display screen or the printing paper 31. Specifically, a pair of images in which the file specifying information 32 corresponding to each file is arranged on the right side, and the picture image 33 is arranged next thereto in the picture thumbnail arranging region on the left side of the file specifying information 32 is outputted based on the unit index data on the display screen or the printing paper 31. The index of the type “PICTURE ONLY” of all the files is outputted based on the entire index data in which a plurality of unit index data are arranged in the vertical direction in two columns.

Therefore, when the user selects the index of the type “PICTURE ONLY”, the user can specify the target file of direct print by simply glancing at the plurality of picture images 33 (picture thumbnail) arranged in the vertical direction in two columns of the display state or the print result of the index based on the picture thumbnail indicating the summary of the picture contained in the file to be direct printed. Also, whether or not text is contained in each file is indicated in the respective file specifying information 32, and thus the user is able to easily distinguish and select the file containing the text from the file containing only the picture when desiring to print the file containing the text among the plurality of files in which the image of the picture image 33 (picture thumbnail) is the same. On the contrary, the file containing only the picture can be easily selected.

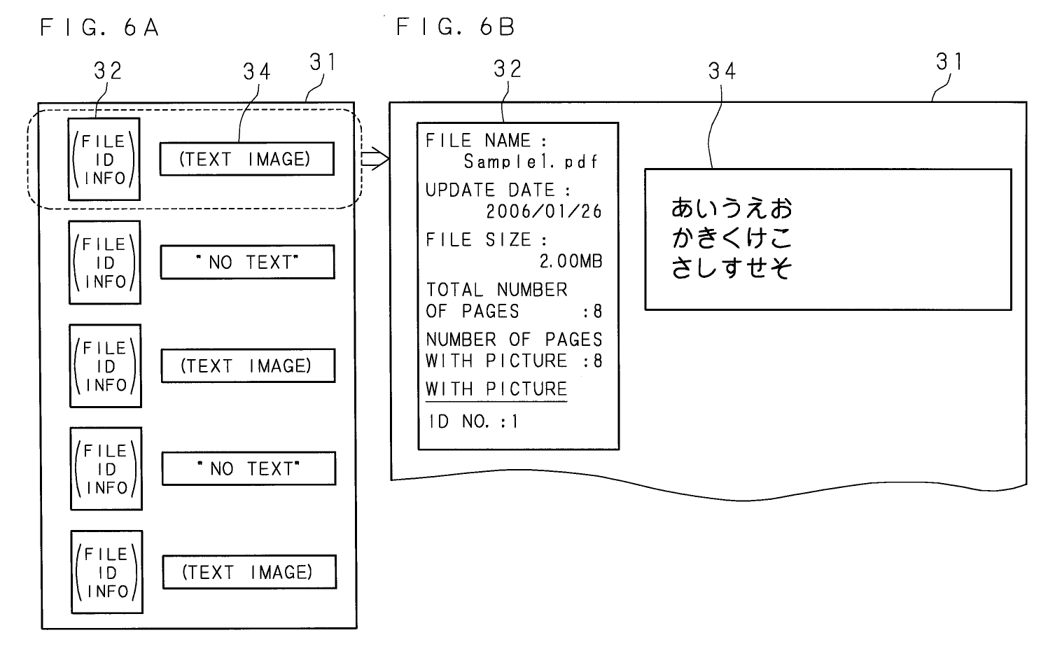

FIG. 6A and FIG. 6B are schematic views showing the display example on the displaying unit 24 or the print result by the printing unit 22 of the index when the user selects the index of the type “TEXT ONLY”. Note that FIG. 6A shows the display example or the print result of the index (entire index data) on one display screen or one sheet of printing paper 31, and FIG. 6B shows the display example or the print result of the index data (unit index data) of one of the files.

The unit index data of each file, that is, the file specifying information 32 and the text image 34 indicating a part of the text contained in the file specified by the file specifying information 32 are displayed or printed side by side (associated) in the left and right direction on the display screen or the printing paper 31. That is, the CPU 10 displays or prints the index image (text image 34 in this case) as thumbnail on the text thumbnail arranging region corresponding to the type (text thumbnail in this case) of the thumbnail outputted by the selected type of index. However, the CPU 10 does not display or print the index image (picture thumbnail in this case) on the picture thumbnail arranging region corresponding to the type (picture thumbnail in this case) of the thumbnail to be outputted by the non-selected type of index.

In the file specifying information 32, information indicating the presence of picture in addition to the file name, last update date, file size, total number of pages, number of pages with picture, as shown in FIG. 4 are contained. The information indicating the presence of picture contained in the file specifying information 32 is auxiliary outputted to indicate whether or not the non-selected type data, which is the data of the index image (picture image 33 in this case) to be arranged in the thumbnail arranging region (picture thumbnail arranging region in this case) corresponding to the type (picture thumbnail in this case) of the thumbnail to be outputted by the non-selected type of index, is contained in the respective file. The user searches for the intended file from the content of the file specifying information 32 and the text image 34 (text thumbnail).

In the display state or the print result of the index shown in FIG. 6A, the text image 34 (text thumbnail) is arranged in a line at a predetermined position on the display screen or the printing paper 31. Specifically, a pair of images in which the file specifying information 32 corresponding to each file is arranged on the left side, and the text image 34 is arranged next thereto in the text thumbnail arranging region on the right side of the file specifying information 32 is outputted based on the unit index data on the display screen or the printing paper 31. Then, the index of the type “TEXT ONLY” of all the files is output based on the entire index data in which a plurality of unit index data are arranged in the vertical direction.

Therefore, when the user selects the index of the type “TEXT ONLY”, the user can specify the target file of direct print by simply glancing at the plurality of text images 34 (text thumbnail) arranged in the vertical direction of the display state or the print result of the index based on the text thumbnail indicating the summary of the text contained in the file to be direct printed. Also, whether or not picture is contained in each file is indicated in the respective file specifying information 32, and thus the user is able to easily distinguish and select the file containing the picture from the file containing only the text when desiring to print the file containing the picture among the plurality of files in which the text of the text image 34 (text thumbnail) is the same. On the contrary, the file containing only the text can be easily selected.

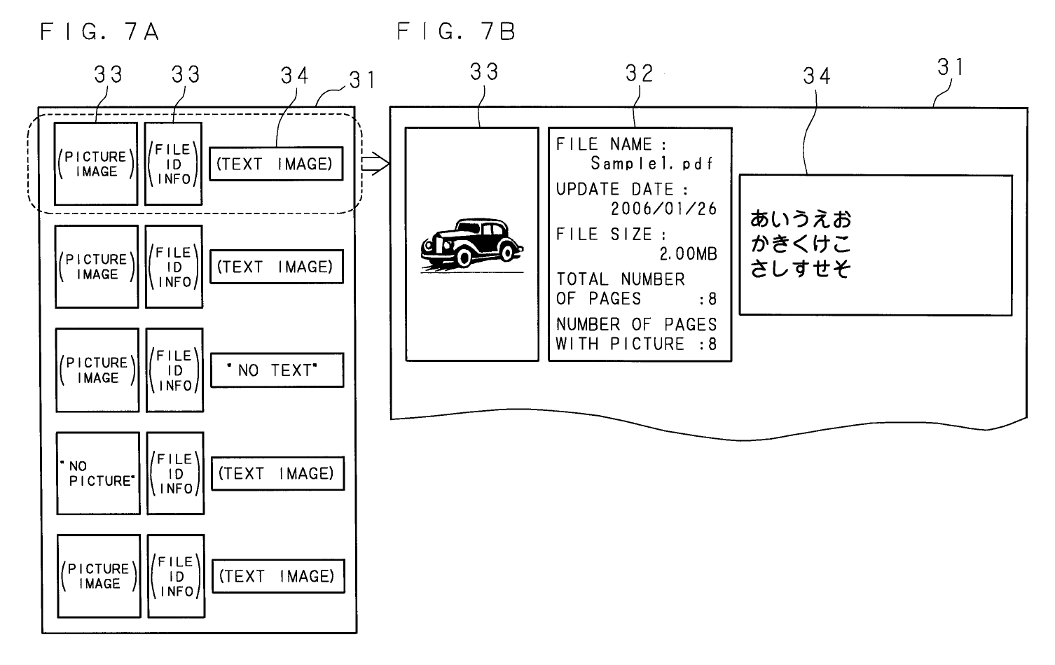

FIG. 7A and FIG. 7B are schematic views showing the display example on the displaying unit 24 or the print result by the printing unit 22 of the index when the user selects the index of the type “PICTURE & TEXT”. Note that FIG. 7A shows the display example or the print result of the index (entire index data) on one display screen or one sheet of printing paper 31, and FIG. 7B shows the display example or the print result of the index data (unit index data) of one of the files.

The unit index data of each file, that is, the file specifying information 32 and the picture image 33 as well as the text image 34 both contained in the file specified by the file specifying information 32 are displayed or printed side by side (associated) in the left and right direction on the display screen or the printing paper 31. That is, the CPU 10 displays or prints the index images (picture image 33 and text image 34 in this case) as thumbnails on the picture thumbnail arranging region and the text thumbnail arranging region corresponding to the type (picture thumbnail and text thumbnail in this case) of the thumbnail, respectively outputted by the selected type of index.

In the file specifying information 32, information on the file name, last update date, file size, total number of pages, number of pages with picture, as shown in FIG. 4 are contained. The text thumbnail of “no text” is outputted to the text thumbnail arranging region for files not containing the text. On the contrary, the picture thumbnail of “no picture” is outputted to the picture thumbnail arranging region for files not containing the picture. That is, when the file does not contain one of either the text data or the picture data, the CPU 10 makes the picture thumbnail arranging region or the text thumbnail arranging region corresponding to the data type not contained become in a predetermined output state which means not containing data, specifically, output state of “no text” or “no picture”. The user searches for the intended file from the content of the file specifying information 32 and the picture image 33 as well as the text image 34.

In the display state or the print result of the index shown in FIG. 7A, the picture image 33 (picture thumbnail) and the text image 34 (text thumbnail) are arranged in a line at a predetermined position on the display screen or the printing paper 31. Specifically, one set of images in which the file specifying information 32 corresponding to each file is arranged in the middle, the picture image 33 is arranged in the picture thumbnail arranging region on the left side of the file specifying information 32, and the text image 34 is arranged in the text thumbnail arranging region on the right side of the file specifying information 32 is outputted based on the unit index data on the display screen or the printing paper 31. The index of the type “PICTURE & TEXT” of all the files is outputted based on the entire index data in which a plurality of unit index data are arranged in the vertical direction. Furthermore, the notification is outputted to the thumbnail arranging regions where the picture image 33 and the text image 34 are to be arranged as thumbnails, respectively with respect to files not containing the picture or the text.

Therefore, when the user selects the index of the type “PICTURE & TEXT”, the user can specify the target file of direct print by simply glancing at the display state or the print result of the index based on the picture thumbnail indicating the summary of the picture or the text thumbnail indicating the summary of the text contained in the document file to be direct printed. In particular, when the user targets a plurality of files for direct print, for example, when desiring to select the document file containing the text for meeting and the graphics file including the picture for resource material to be used in explaining the document file and the like, the file can be specified from both the text thumbnail indicating the summary of the text and the picture thumbnail indicating the summary of the picture, and thus rapid selection becomes possible.

Also, with regard to files not containing the picture or the text, the notification is outputted to the thumbnail arranging regions where the picture image 33 and the text image 34 are arranged as thumbnails, respectively, as the picture thumbnail and the text thumbnail. Therefore, the arrangement state with respect to the file specifying information 32 of the picture image 33 (picture thumbnail) and the text image 34 (text thumbnail) is the same as the arranging positions of the picture thumbnail arranging region and the text thumbnail arranging region defined in advance with respect to the file specifying information 32, whereby the files not containing the picture and the files not containing the text are easily distinguished by the user.

The following processes will be described referring again to the flow chart of FIG. 3C. When the output (display or print) of the generated entire index data is completed (step S17), the CPU 10 judges whether or not the index of the type “TEXT ONLY” is selected in former step S6 (step S18). When the type of index selected by the user is not “TEXT ONLY” (step S18: NO), the CPU 10 terminates the generating process of the index data.

On the other hand, when the index of the type selected by the user is “TEXT ONLY” (step S18: YES), the CPU 10 inquires the user whether or not the index of the type “PICTURE ONLY” is necessary (step S19). When the user instructs that the index of the type “PICTURE ONLY” is not necessary (step S19: NO), the CPU 10 terminates the generating process of the index data.

However, when the user instructs that the index of the type “PICTURE ONLY” is necessary (step S19: YES), the CPU 10 urges the user to input the identifying information given to the file that requires index by displaying on the display panel of the displaying unit 24 and the like. According to this, when the input of the identifying information is completed by operating the key switch group of the operation unit 23 by the user (step S20: YES), the CPU 10 generates one set of unit index data in which only the picture image 33 is associated with the file specifying information 32 with one or a plurality of files of the inputted identifying information (identification number) as the target (step S21). The CPU 10 then generates the data of the entire index (index of “PICTURE ONLY”) similar to the above from the generated one or a plurality of unit index data, and outputs (displays or prints) the same (step S22). That is, the CPU 10 additionally displays or prints with the non-selected type data (data of picture image 33 in this case) of the file corresponding to the inputted identifying information as the index.

From the above results, the user is able to output the index of the type “TEXT ONLY” and then output the index of the type “PICTURE ONLY” by selecting an arbitrarily one or a plurality of files containing the picture from the result thereof.

In either case, the user is able to easily search for the file intending to perform direct print by looking at the final index output result (display state or printing state), and have the MFP 1 perform direct print by designating the relevant file.

In embodiment 1 described above, an example of additionally outputting the index of the picture image 33, which is the non-selected type data, when the index of the type selected by the user is “TEXT ONLY” (S18: YES) has been described. Obviously, however, the index of the text image 34, which is the non-selected type data, may be additionally outputted when the index of the type selected by the user is “PICTURE ONLY”.

Furthermore, an example of display outputting the index to the displaying unit 24 or print outputting with the printing unit 22 has been described in embodiment 1. However, a configuration of only displaying the index by the displaying unit 24 or a configuration of only printing the index by the printing unit 22 may be adopted.

When the number of files is large, the index of all the files can be displayed or printed by reducing the index of each file according to the number of files, or by scrolling the display screen or by printing on a plural of printing papers. When the display screen of the displaying unit 24 is small or is horizontally long, the index of all the files are displayed by scrolling.

### Embodiment 2

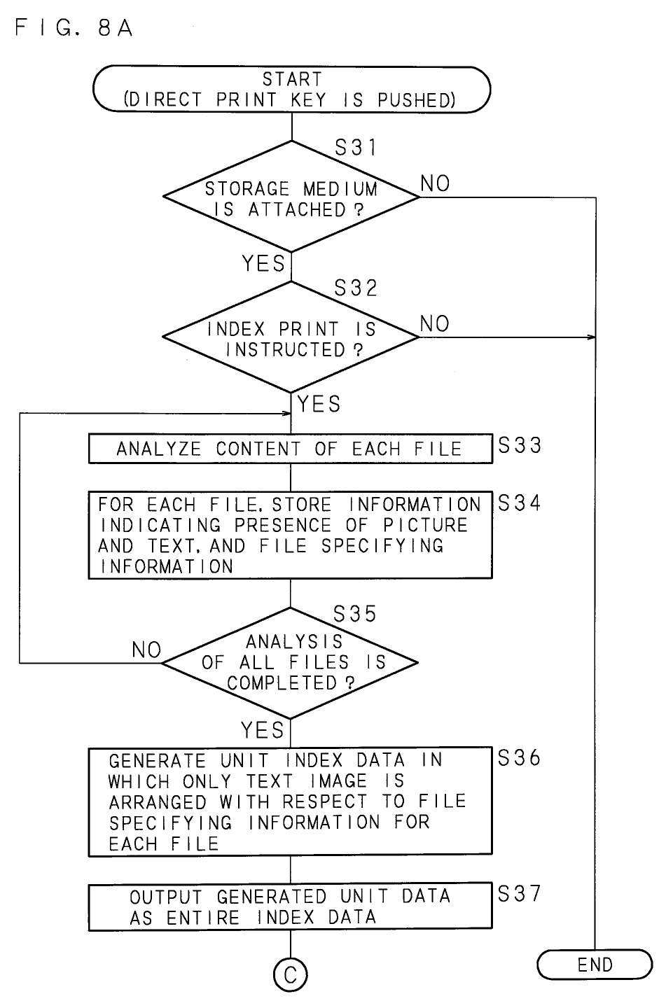

The procedures of the index data generating process of embodiment 2 by the index data generating function of the MFP 1 as a print apparatus according to the present invention will now be described with reference to the flow charts of FIG. 8A and FIG. 8B. In embodiment 2, one of either the text image 34 or the picture image 33 is outputted as index with the file specifying information 32 to the first display screen or the first printing paper 311. The other image is outputted as index to the second display screen or the second printing paper 312 in the same arrangement as the index outputted to the first display screen or the first printing paper 312.

A case where the text image 34 is outputted as index with the file specifying information 32 to the first display screen or the first printing paper 311, and the picture image 33 is outputted as index to the second display screen or the second printing paper 312 will be described below.

When the user pushes the direct print key in the key switch group of the operation unit 23 of the MFP 1, the CPU 10 of the MFP 1 executes the index data generating process according to the procedures of the flow charts of FIG. 8A and FIG. 8B, prior to printing the file for direct print of the file stored in the storage medium 28.

First, the CPU 10 of the MFP 1 judges whether or not the storage medium 28 is attached to the slot unit 25 (step S31). When the storage medium 28 is not attached (step S31: NO), the file to be direct printed is not present, and thus the CPU 10 terminates the process.

When the storage medium 28 is attached to the slot unit 25 (step S31: YES), the CPU 10 monitors whether or not the instruction for index print given by the user is accepted (step S32). When the instruction of index print is not accepted (S32: NO), the process of index print is not performed. For example, index print is not necessary when all the files are to be printed. When the user instructs index print by operating the operation unit 23 (step S32: YES), the CPU 10 executes the index data generating program 12f according to the accepted key operation and executes the following processes.

First, the CPU 10 sequentially analyzes the content of each file stored in the storage medium 28 in a predetermined order (step S33). For each file from the result of analysis, the CPU 10 associates and stores in the memory (RAM 11) the information indicating the presence of pictures and the information indicating the presence of text, and the file specifying information 32 (size, number of pages and the like) specifying each file (step S34).

The CPU 10 then judges whether or not the analysis of all the files stored in the storage medium 28 attached to the slot unit 25 is completed (step S35). When the analysis of all the files is not completed (step S35: NO), the CPU 10 returns the process to step S33 and repeats the processes described above.

When the analysis of all the files is completed (step S35: YES), the CPU 10 extracts the text data corresponding to at least a part of the text (e.g., added with only a few lines) as text data for text thumbnail for all the files containing the text. The CPU 10 generates the text image 34 based on the text data extracted in this manner, and arranges the same in the text thumbnail arranging region set at a predetermined position with respect to the arranging region of the corresponding file specifying information 32 and generates one set of unit index data with respect to files containing the text (S36). Note that the text image 34 used as the text thumbnail is generated based on the text data of “no text”, similar to embodiment 1, and the unit index data is generated similar to the above for files not containing the text.

After the generation of the unit index data is completed for all the files as described above, the CPU 10 generates an entire index data by laying out each unit index data in a predetermined shape (format). The entire index data generated in the above manner is outputted (displayed) on the displaying unit 24 by executing the display program 12a by the CPU 10. When the user operates the operation unit 23 to instruct printing, the CPU 10 executes the printing program 12b, and the printing unit 22 outputs (prints) the entire index data on the appropriate printing paper (first printing paper 311) (step S37).

As shown in the flow chart of FIG. 8B, the CPU 10 then inquires the user whether or not the index of the type “PICTURE ONLY” is necessary (step S38). When the user instructs that the index of the type “PICTURE ONLY” is not necessary (step S38: NO), the CPU 10 terminates the generating process of the index data.

However, when the user instructs that the index of the type “PICTURE ONLY” is necessary (step S38: YES), the CPU 10 judges the presence of the file in which the number of pages of “WITH PICTURE” in each file specifying information 32 is greater than or equal to a predetermined value (step S39). When the file in which the number of pages of “WITH PICTURE” is greater than or equal to a predetermined value (step S39: YES), the CPU 10 generates the picture data of a plurality of pages by reducing picture size of the file (step S40), and proceeds the process to step S41. When the file in which the number of pages of “WITH PICTURE” is greater than or equal to a predetermined value is not present (step S39: NO), the CPU 10 directly proceeds the process to step S41.

When the file in which the number of pages of “WITH PICTURE” is greater than or equal to a predetermined value is not present, the CPU 10 extracts the picture having characteristics such as the largest size or color picture from the original picture data for each file containing the picture according to predetermined conditions (step S41). When the file in which the number of pages of “WITH PICTURE” is greater than or equal to a predetermined value is present, the CPU 10 extracts the picture having characteristics such as the largest size or color picture from the plurality of reduced picture data generated in step S40 according to predetermined conditions (step S41). The CPU 10 then extracts the picture data corresponding to at least a part of the extracted image as picture data for picture thumbnail with respect to each file. The CPU 10 generates the picture image 33 based on the picture data extracted in the above manner and arranges the same in the picture thumbnail arranging region set at a predetermined position with respect to the arranging region of the corresponding file specifying information 32 and generates one unit index data (step S42).

With regard to the files not containing the picture, the CPU 10 generates the picture image 33 for picture thumbnail based on the text data of “no picture”, and arranges the same in the picture thumbnail arranging region set at the predetermined position with respect to the arranging region of the corresponding file specifying information 32 and generates one set of unit index data with respect to each file not containing the picture in the process of step S42.

After the generation of the unit index data is completed for all the files in the above manner, the CPU 10 generates the entire index data for the index of the type “PICTURE ONLY” by laying out each unit index data in a predetermined shape (format) on the second display screen or the second printing paper 312. The entire index data generated in this manner is outputted to the display screen or the printing paper different from the index associating the file specifying information 32 and the text thumbnail as the index of only the picture thumbnail. Specifically, the CPU 10 executes the display program 12a to display the index of only the picture thumbnail on the displaying unit 24 as the second display screen. Furthermore, when the user operates the operation unit 23 to instruct printing, the CPU 10 executes the printing program 12b, and the printing unit 22 prints the index of only the picture thumbnail on the appropriate printing paper (second printing paper 312) (step S43).

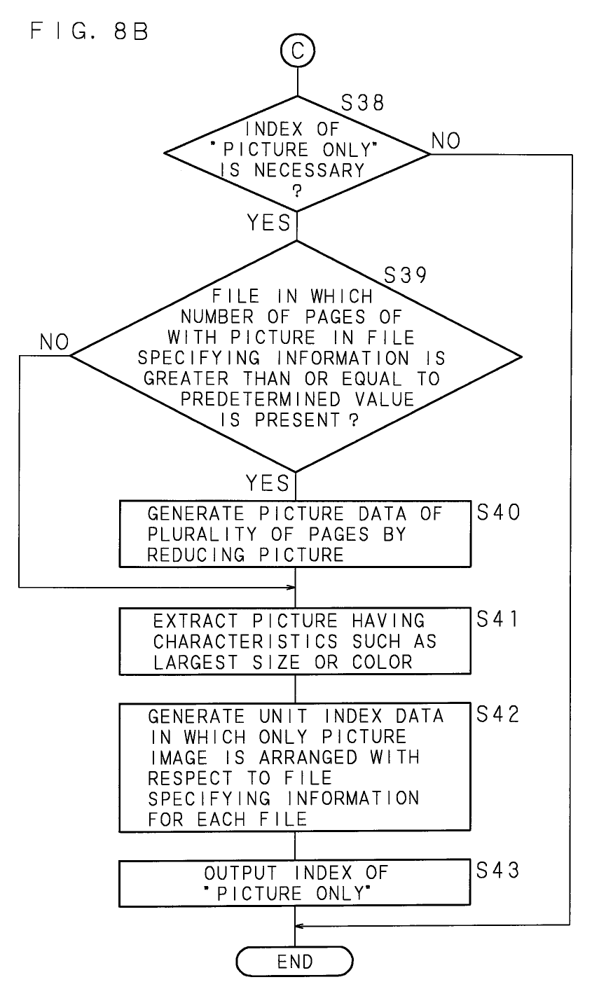

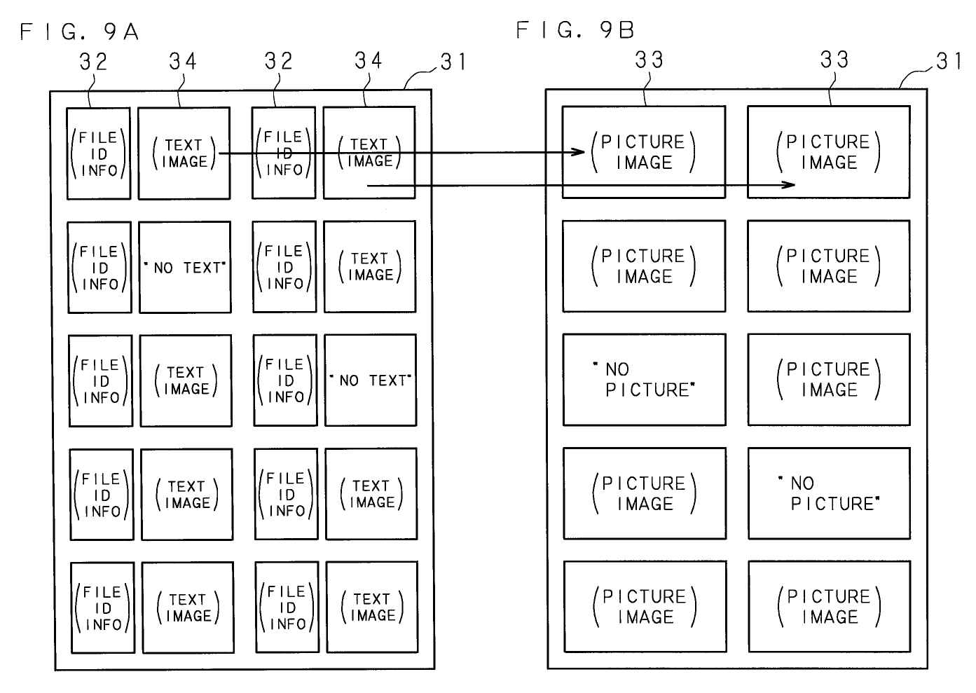

FIG. 9A and FIG. 9B are schematic views showing the display state and the print result when the file specifying information 32 and the text image 34 (text thumbnail) corresponding to each file are outputted to the same first display screen or the first printing paper 311, and the picture image 33 (picture thumbnail) is outputted to the second display screen or the second printing paper 312.

As shown in FIG. 9A, the file specifying information 32 and the text image 34 (text thumbnail) corresponding to each file are outputted to the first display screen or the first printing paper 311. Also, as shown in FIG. 9B, the picture image 33 is outputted as the picture thumbnail at each position on the second display screen or the second printing paper 312 each corresponding to the output position on the first display screen or the first printing paper 311 of the file specifying information 32 and the text image 34 of each file. In the example shown in FIG. 9B, note that the picture image 33 (picture thumbnail) is outputted to the second display screen or the second printing paper 312 one by one according to each file.

In other words, each picture image 33 (picture thumbnail) outputted to the second display screen or the second printing paper 312 is outputted to the same position on the second display screen or the second printing paper 312 as the output position of the file specifying information 32 and the text image 34 (text thumbnail) outputted to the first display screen or the first printing paper 311 based on the file corresponding to the picture image 33 (picture thumbnail). Therefore, the user is able to easily recognize to which file, outputted as the index on the first display screen or the first printing paper 311, the picture image 33 (picture thumbnail) outputted to the second display screen or the second printing paper 312 corresponds to.

At this time, the picture thumbnail “no picture” is outputted to the second display screen or the second printing paper 312 for the files not containing the picture, and thus the arrangement state of the index (file specifying information 32 and text thumbnail) of each file on the first display screen or the first printing paper 311 and the arrangement state of the index (picture thumbnail) of each file on the second display screen or the second printing paper 312 completely match. Therefore, the user is able to easily recognize the correspondence of the picture thumbnail outputted to the second display screen or the second printing paper 312 corresponding to each file of the index outputted to the first display screen or the first printing paper 311, and is also able to easily recognize which file is the file that does not contain the picture from the index outputted to the first display screen or the first printing paper 311.

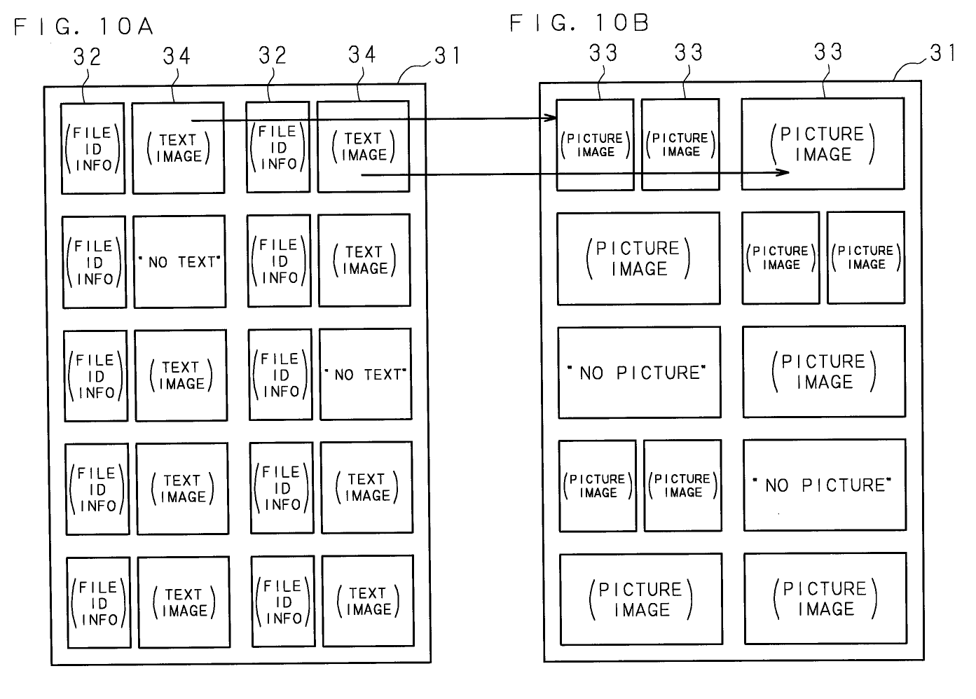

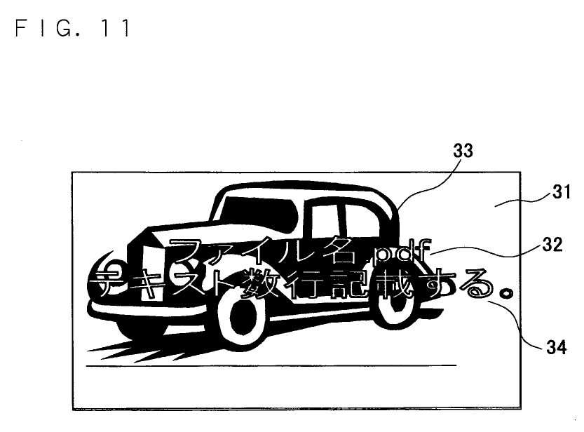

FIG. 10A and FIG. 10B are schematic views showing an example in which one or a plurality of picture images 33 (picture thumbnails) is outputted to the second display screen or the second printing paper 312 when the files containing a plurality of pictures is present in embodiment 2.

The output state on the first display screen or the first printing paper 311 shown in FIG. 10A is the same as the output state shown in FIG. 9A described above. However, when the file containing a plurality of pictures is present, a plurality of picture images 33 are outputted as picture thumbnails at the position on the second display screen or the second printing paper 312 corresponding to the output position on the first display screen or the first printing paper 311 of the file specifying information 32 and the text image 34 (text thumbnail) of each file, as shown in FIG. 10B. Therefore, when a plurality of picture thumbnails are outputted to the second display screen or the second printing paper 312, the user is able to easily recognize the file containing the plurality of pictures.

In either the output state of the index shown in FIG. 9A and FIG. 9B or the output state of the index shown in FIG. 10A and FIG. 10B, the file specifying information 32 and the text image 34 (text thumbnail) corresponding to each file are outputted to the first display screen or the first printing paper 311, and the index of the picture thumbnail is outputted to the second display screen or the second printing paper 312 in the same arrangement as the arrangement of the index of each file on the first display screen or the first printing paper 311 when the user additionally instructs the output of the index of the type “PICTURE ONLY”. Therefore, when the index of the picture thumbnail is unnecessary, the index of the picture thumbnail will not be outputted to the second display screen or the second printing paper 312 unless the user additionally instructs the output of the index of the type “PICTURE ONLY”. Therefore, the user is not forced to wait for a wasteful time.

In embodiment 2 described above, an example of additionally outputting to the second display screen or the second printing paper 312 the index having the data of the picture image 33, which is the non-selected type data, as the picture thumbnail when printing of index is instructed by the user (S32: YES) has been described. On the contrary, the index having the data of the text image 34, which is the non-selected type data, as the text thumbnail may be additionally outputted to the second display screen or the second printing paper 312. Which type of thumbnail to output to the first display screen or the first printing paper 311 may be selected by the instruction of the user or by setting it as default.

Furthermore, an example of display outputting the index to the displaying unit 24 or print outputting with the printing unit 22 has been described in embodiment 2. However, a configuration of only displaying the index by the displaying unit 24 or a configuration of only printing the index by the printing unit 22 may be adopted.

### Embodiment 3

In embodiment 2 described above, an example in which the file specifying information 32, the picture image 33 (picture thumbnail) and the text image 34 (text thumbnail) are arranged at positions not overlapping each other has been described, but the file specifying information 32, the picture image 33 (picture thumbnail) and the text image 34 (text thumbnail) may be composed and print output in a form overlapping each other.

The generating process of watermark index, which is an example of composing and outputting the file specifying information 32, the picture image 33 and the text image 34 in an overlapping form will now be described in embodiment 3 below. FIG. 11 is a schematic view showing the result of the generating process of the watermark index.

As shown in FIG. 11, the picture image 33, the text image 34 and the file specifying information 32 are outputted in an overlapping state to the same display screen or the same printing paper 31 in the generating process of the watermark index. Specifically, by executing the index data generating program 12f by the CPU 10, the text thumbnail arranging region for arranging the text image 34 based on the text data for text thumbnail generated from each file, and the picture thumbnail arranging region for arranging the picture image 33 based on the picture data for picture thumbnail generated from each file are set in the same region as the region for arranging the file specifying information 32 of each file. As a result, the picture image 33, the text image 34 and the file specifying information 32 are outputted in an overlapping state to the same display screen or the same printing paper 31.

According to such generating process of the watermark index, the displaying space or the printing space is saved and the printing time is saved as compared with embodiment 2.

According to the present invention described in detail above, the index is outputted for each file with the text image 34 and/or the picture image 33 as the text thumbnail and/or picture thumbnail together with the file specifying information 32. Therefore, the user is able to easily find the intended file and rapidly print the intended file by looking at the result of the index output.

According to the present invention, the file specifying information 32 including information indicating the presence of picture data (or text data) and the text image 34 (or picture image 33) are outputted as the indexes for each file, so that the user can easily find the file in which the picture data (or text data) is present, as necessary, and additionally output the index having the relevant picture image 33 (or text image 34) as the thumbnail.

Furthermore, according to the present invention, the file specifying information 32 and the text image 34 (or picture image 33) are outputted as indexes to the first display screen or the first printing paper 311 with respect to each file, and the index having the picture image 33 (or text image 34) as the thumbnail is additionally outputted to the position on the second display screen or the second printing paper 312 corresponding to the output position of the file specifying information 32 and the text image 34 (or picture image 33) on the first display screen or the first printing paper 311. Therefore, the index having the picture image 33 (or text image 34) as the picture thumbnail (or text thumbnail) does not need to be outputted to the second display screen or the second printing paper 312 if not necessary, whereby the displaying space is saved or the printing paper is saved, and the printing time is saved.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds there-of are therefore intended to be embraced by the claims.

What is claimed is:

1. A data generating apparatus comprising:
an extracting unit that extracts, from a file, text data corresponding to at least a part of a text contained in the file and picture data corresponding to at least a part of a picture contained in the file;
a setting unit that, for each file, sets a text thumbnail arranging region for arranging a text thumbnail using the text data extracted by the extracting unit and a picture thumbnail arranging region for arranging a picture thumbnail using the picture data extracted by the extracting unit; and
an index data generating unit that generates index data for outputting image of an index by arranging the extracted text data and the extracted picture data as a text thumbnail and a picture thumbnail in the text thumbnail arranging region and the picture thumbnail arranging region set for each file, respectively correspondingly to file specifying information for specifying each file.

2. The data generating apparatus as set forth in claim 1, wherein the setting unit sets the text thumbnail arranging region and the picture thumbnail arranging region corresponding to the same file as regions not overlapping each other.

3. The data generating apparatus as set forth in claim 2,
wherein the index data generating unit arranges a predetermined thumbnail indicating that text is not contained in the text thumbnail arranging region when the file does not contain a text, and
arranges a predetermined thumbnail indicating that picture is not contained in the picture thumbnail arranging region when the file does not contain a picture.

4. The data generating apparatus as set forth in claims 3, further comprising an accepting unit that accepts an instruction for selecting whether a type of thumbnail to be generated by the index data generating unit is a text thumbnail or a picture thumbnail,
wherein the index data generating unit arranges a thumbnail of the type selected by the instruction accepted by the accepting unit, and does not arrange a thumbnail of the type not selected.

5. The data generating apparatus as set forth in claim 4, wherein the index data generating unit adds, for each file, information indicating that data corresponding to the thumbnail of the type not selected is contained.

6. The data generating apparatus as set forth in claim 5, wherein
the index data generating unit adds unique identifying information to the file specifying information of the file in which the data corresponding to the thumbnail of the type not selected is contained;
an accepting unit that accepts designation of the added identifying information is provided;
the extracting unit extracts data corresponding to at least a part of a data corresponding to the thumbnail of the type not selected contained in the file corresponding to the identifying information accepted by the accepting unit; and
the index data generating unit generates index data using the data extracted by the extracting unit as the thumbnail.

7. The data generating apparatus as set forth in claim 1, wherein the index data generating unit
arranges a predetermined thumbnail indicating that text is not contained in the text thumbnail arranging region when the file does not contain a text, and
arranges a predetermined thumbnail indicating that picture is not contained in the picture thumbnail arranging region when the file does not contain a picture.

8. The data generating apparatus as set forth in claim 7, further comprising an accepting unit that accepts an instruction for selecting whether a type of thumbnail to be generated by the index data generating unit is a text thumbnail or a picture thumbnail,
wherein the index data generating unit arranges a thumbnail of the type selected by the instruction accepted by the accepting unit, and does not arrange a thumbnail of the type not selected.

9. The data generating apparatus as set forth in claim 8, wherein the index data generating unit adds, for each file, information indicating that data corresponding to the thumbnail of the type not selected is contained.

10. The data generating apparatus as set forth in claim 9, wherein
the index data generating unit adds unique identifying information to the file specifying information of the file in which the data corresponding to the thumbnail of the type not selected is contained;
an accepting unit that accepts designation of the added identifying information is provided;
the extracting unit extracts data corresponding to at least a part of a data corresponding to the thumbnail of the type not selected contained in the file corresponding to the identifying information accepted by the accepting unit; and
the index data generating unit generates index data using the data extracted by the extracting unit as the thumbnail.

11. The data generating apparatus as set forth in claim 1, wherein the setting unit
separates and sets the text thumbnail arranging region to a first output medium and the picture thumbnail arranging region to a second output medium, respectively, and
sets an arrangement position of the thumbnail arranging region in the first output medium and an arrangement position of the thumbnail arranging region in the second output medium in accordance with each file.

12. The data generating apparatus as set forth in claim 1, wherein the setting unit sets the text thumbnail arranging region and the picture thumbnail arranging region corresponding to the same file as a region overlapping each other.

13. A print apparatus including:
a data generating apparatus comprising: an extracting unit that extracts, from a file, text data corresponding to at least a part of a text contained in the file and picture data corresponding to at least a part of a picture contained in the file; a setting unit that, for each file, sets a text thumbnail arranging region for arranging a text thumbnail using the text data extracted by the extracting unit and a picture thumbnail arranging region for arranging a picture thumbnail using the picture data extracted by the extracting unit; and an index data generating unit that generates index data for outputting image of an index by arranging the extracted text data and the extracted picture data as a text thumbnail and a picture thumbnail in the text thumbnail arranging region and the picture thumbnail arranging region set for each file, respectively correspondingly to file specifying information for specifying each file; and
a printing unit that prints the index data generated by the index data generating unit.

14. The print apparatus as set forth in claim 13, wherein the setting unit sets the text thumbnail arranging region and the picture thumbnail arranging region corresponding to the same file as regions not overlapping each other.

15. The print apparatus as set forth in claim 14, wherein the index data generating unit
arranges a predetermined thumbnail indicating that text is not contained in the text thumbnail arranging region when the file does not contain a text, and
arranges a predetermined thumbnail indicating that picture is not contained in the picture thumbnail arranging region when the file does not contain a picture.

16. The print apparatus as set forth in claim 15, wherein
the data generating apparatus further comprises an accepting unit that accepts an instruction for selecting whether a type of thumbnail to be generated by the index data generating unit is a text thumbnail or a picture thumbnail, and
the index data generating unit arranges a thumbnail of the type selected by the instruction accepted by the accepting unit, and does not arrange a thumbnail of the type not selected.

17. The print apparatus as set forth in claim 16, wherein the index data generating unit adds, for each file, information indicating that data corresponding to the thumbnail of the type not selected is contained.

18. The print apparatus as set forth in claim 17, wherein
the index data generating unit adds unique identifying information to the file specifying information of the file in which the data corresponding to the thumbnail of the type not selected is contained;
the data generating apparatus further comprising an accepting unit that accepts designation of the added identifying information is provided;
the extracting unit extracts data corresponding to at least a part of a data corresponding to the thumbnail of the type not selected contained in the file corresponding to the identifying information accepted by the accepting unit; and
the index data generating unit generates index data using the data extracted by the extracting unit as the thumbnail.

19. The print apparatus as set forth in claim 13, wherein the index data generating unit
arranges a predetermined thumbnail indicating that text is not contained in the text thumbnail arranging region when the file does not contain a text, and
arranges a predetermined thumbnail indicating that picture is not contained in the picture thumbnail arranging region when the file does not contain a picture.

20. The print apparatus as set forth in claim 19, wherein
the data generating apparatus further comprises an accepting unit that accepts an instruction for selecting whether a type of thumbnail to be generated by the index data generating unit is a text thumbnail or a picture thumbnail, and
the index data generating unit arranges a thumbnail of the type selected by the instruction accepted by the accepting unit, and does not arrange a thumbnail of the type not selected.

21. The print apparatus as set forth in claim 20, wherein the index data generating unit adds, for each file, information indicating that data corresponding to the thumbnail of the type not selected is contained.

22. The print apparatus as set forth in claim 21, wherein
the index data generating unit adds unique identifying information to the file specifying information of the file in which the data corresponding to the thumbnail of the type not selected is contained;
the data generating apparatus further comprising an accepting unit that accepts designation of the added identifying information is provided;
the extracting unit extracts data corresponding to at least a part of a data corresponding to the thumbnail of the type not selected contained in the file corresponding to the identifying information accepted by the accepting unit; and
the index data generating unit generates index data using the data extracted by the extracting unit as the thumbnail.

23. The print apparatus as set forth in claim 13, wherein the setting unit
separates and sets the text thumbnail arranging region to a first printing paper and the picture thumbnail arranging region to a second printing paper, respectively, and
sets an arrangement position of the thumbnail arranging region in the first printing paper and an arrangement position of the thumbnail arranging region in the second printing paper in accordance with each file.

24. The print apparatus as set forth in claim 13, wherein the setting unit sets the text thumbnail arranging region and the picture thumbnail arranging region corresponding to the same file as a region overlapping each other.
